(19) United States
(12) Patent Application Publication
(10) Pub. No.: US 2026/0056018 A1
(43) Pub. Date: Feb. 26, 2026

(54) Locating System for Determining Relative Position Information

(71) Applicant: Robert Bosch GmbH, Stuttgart (DE)

(72) Inventors: Dirk Eichel, Bietigheim-Bissingen (DE); Jan-Michael Brosi, Leinfelden-Echterdingen (DE); Heiko Sgarz, Leonberg (DE)

(21) Appl. No.: 19/302,498

(22) Filed: Aug. 18, 2025

(30) Foreign Application Priority Data
Aug. 21, 2024 (DE) 10 2024 207 906.5

(51) Int. Cl. G01C 21/00

(52) U.S. Cl. CPC G01C 21/005

(57) ABSTRACT

A locating system for determining relative position information with respect to a relative position of the locating system relative to an object to be located below an examination surface is disclosed. The locating system has a locating sensor, an orientation sensor, and an evaluation device. The locating sensor is configured to provide a first signal which changes with a change in a distance between the locating system and the object. The orientation sensor is configured to provide a second signal which changes with a change in a direction of movement of the locating system relative to an environment of the locating system. The evaluation device is configured to determine the relative position information with respect to the relative position of the locating system relative to the object, taking into account the first signal and the second signal.

This application claims priority under 35 U.S.C. § 119 to application no. DE 10 2024 207 906.5, filed on Aug. 21, 2024 in Germany, the disclosure of which is incorporated herein by reference in its entirety.

The present disclosure relates to the field of locating devices and relates to a locating system for determining relative position information and a method for determining relative position information.

### BACKGROUND

From the prior art, locating devices are known that serve to locate invisible objects within walls, ceilings, and/or floors and that can display an object in a more or less large area (object display area) around a center of the object (object center). Within the object display area, for example by using a sensor array or by way of different sensor orientations and/or sensor excitations, an additional display is realized as to the direction in which the object center is located. Another known possibility is to use precise path sensors in addition to a locating sensor to locate the object in order to determine the direction of the object center. The known devices that realize such a direction indicator have the disadvantage that they are complex, prone to errors, and/or are expensive to manufacture.

For example, WO 2015/197790 A2 describes a locating system having a locating device which is intended to capture locating data relating to locating objects hidden below an examination interface, with a locating sensor for capturing position data of the locating device relative to the examination surface. It is described that the locating system comprises at least one evaluation device which is intended, at least in a first operating mode of the locating system, to determine directionally and/or spatially resolved location information from the locating data without repositioning the locating device relative to the examination surface and, in a second operating mode, to determine at least three-dimensional location information from the locating data and the position data by assigning locating data to position data.

### SUMMARY

The present disclosure discloses a locating system for determining relative position information with respect to a relative position of the locating system relative to an object to be located below an examination surface, and a method for determining corresponding relative position information.

According to a first aspect, a locating system for determining relative position information with respect to a relative position of the locating system relative to an object to be located (locating object) which is located below an examination surface is proposed, wherein the locating system may be in particular be a handheld locating device.

A locating system within the meaning of the present disclosure is a device that makes it possible to locate invisible objects within walls, ceilings and/or floors. These objects may be, for example, gas, water or power lines, reinforcing steel, or stand constructions. A locating device within the meaning of the present disclosure is a locating system that is suitable for direct use by a human user (hereinafter also referred to as a user) by comprising suitable input and output elements and preferably a housing. In a locating device, the entire locating device represents a locating system within the meaning of the disclosure, but the locating device minus the input and output elements and any housing present is also a locating system. Preferably, a locating system according to the present disclosure is a portable and/or handheld locating device. A locating system according to the present disclosure or a part of a locating system according to the present disclosure is typically moved over an examination surface under which one or more locating objects are hidden to determine relative position information.

The locating system has a locating sensor, an orientation sensor, and an evaluation device. The locating sensor and orientation sensor are collectively referred to as locating device. They may be accommodated in a housing of the locating system that is structurally separate from the rest of the locating system. Preferably, the locating sensor and the orientation sensor, i.e., the locating device, are positioned within a common housing of the locating system, which is movable over the examination surface, either together with the rest of the locating system or as a structurally separate unit. The evaluation device typically comprises one or more processors and one or more memory modules.

A handheld locating device is to be understood in particular to mean that at least the locating device or a unit of the locating device comprising the locating device is designed to be held only with the hands, in particular with one hand, without the aid of a transport machine. Preferably, the entire locating device is designed to be held only with the hands, in particular with one hand, without the aid of a transport machine. Typically, a handheld locating device is configured in such a way that it can be moved handheld over the examination surface, such as a wall surface, during a measurement process in a movement freely executed by a user of the locating device, in particular a free movement along two directions. For example, the mass of a handheld locating device is less than 5 kg, preferably less than 3 kg, more preferably less than 1 kg, and more preferably less than 500 g. Preferably, a handheld locating device comprises a housing having a handle and/or a grip area with which the locating device can be guided, i.e., moved, over the examination surface.

Relative position information within the meaning of the present disclosure is information such as distance information and/or angle information, which makes it possible to at least partially specify a relative position of at least a part of the locating system (for example, the locating device of the locating system and/or the entire locating system) relative to the object to be located. For example, it may be or comprise an optionally estimated or rounded distance to the object to be located and/or an estimated direction of the object to be located, in each case with respect to at least a portion of the locating system. As a part of the relative position information and/or in addition to the relative position information, further information may also be determined by the locating system, for example an optionally estimated orientation of at least a portion of the locating system with respect to the object to be located (relative orientation) can be determined by the locating system.

For example, the distance may be defined by the distance between a predefined reference point of the locating system, for example the locating device or the entire locating system, and a predefined point of the object, for example the object center, while the relative orientation refers to an orientation of a predefined reference axis of the locating system with respect to the predefined reference axis of the object to be located. The direction of the object to be located relative to the locating system is a direction in which the object lies relative to the locating system, the direction being defined by the orientation of the connecting axis between a point of the locating system and a point of the object. Such a direction can therefore be indicated in particular in the form of a vector that is directed towards a point of the object to be located starting from a point of the locating system.

In the context of this disclosure, formulations such as terms, definitions, indications, and findings regarding a locating system, for example regarding a movement, a position, and/or orientation of the locating system, are to be understood to refer to only a portion of the locating system, for example, a locating device of the locating system. This is particularly relevant because a locating system can consist of a plurality of spatially and/or structurally separate units. For example, a relative orientation of a locating system indicates the orientation of an object to be located relative to at least a portion of the locating system. Furthermore, a relative position is given by a distance and a relative orientation of the locating system or a part of the locating system relative to the object to be located.

Preferably, relative position information includes at least information regarding a direction of the object to be located relative to the locating system. A relative position information need not be exact information, e.g. it may be an estimate for a distance value and/or angular value. Measurement errors may therefore be accepted for relative position information and/or measured values can be rounded in order to obtain relative position information. In particular, relative position information may therefore be an estimated direction and/or distance of the object (i.e. corresponding to the real values only within an error range) in relation to the locating system or a part of the locating system. However, after obtaining more information about the direction and/or the distance of the object, for example after passing over the object, relative position information may also correspond to an exact (detected) position and/or the exact (detected) direction of the object.

The locating sensor is configured to provide a first electrical signal (also referred to briefly as a first signal) that changes with a change in a distance between the locating system and the object. Here, the distance between the locating system and the object is related to any predefined reference point of the locating system, for example a point of the locating device of the locating system, and any predefined point of the object, for example its center (object center). In principle, locating sensors are suitable for detecting locating objects located below an examination surface, for example by evaluating a change in the electric and/or magnetic field or a change in the runtime of radiation emitted into a material to be examined. Preferably, the locating sensor may comprise or be an inductive sensor, a current sensor (in particular, a sensor for detecting line-carrying mains voltage), and/or a capacitive sensor, for example. The locating sensor may also be or comprise a sensor configured to detect locating objects by way of electromagnetic radiation, such as in particular a microwave sensor, a radar sensor, a terahertz sensor, an ultra-high frequency sensor, an X-ray sensor, an infrared sensor, and/or an NMR sensor. Further, the locating sensor may also be or comprise a sonic sensor, for example an ultrasonic sensor, an impact echo sensor, and/or a neutron probe. Preferably, a combination of several, in particular different, sensor types in a common locating sensor is also conceivable. The use of multiple locating sensors in a locating system is also possible.

The orientation sensor is configured to provide a second electrical signal (also referred to as a second signal) that changes with a change in a direction of movement of the locating system relative to an environment of the locating system, i.e. when an orientation of the locating system with respect to the environment changes with simultaneous movement of the locating system relative to the environment. It is not necessary for the orientation sensor to capture a change in an orientation of the locating system in relation to the environment when the positioning system is stationary in relation to the surroundings. In particular, it is not necessary for a change in the orientation of the locating system in relation to the environment to lead to a change in the second signal when the locating system is stationary in relation to the environment. However, this is preferably the case. An environment of the locating system within the scope of the disclosure is to be understood to mean an environment comprising the locating system, the location and orientation of which is constant in time with respect to the examination surface.

An orientation of the locating system with respect to the environment is defined herein as an orientation of a predefined reference axis of at least a portion of the locating system, for example an axis of the locating device of the locating system, with respect to a predefined axis that is constant in time relative to the environment. A change in the direction of movement of the locating system also results in a change in orientation of the locating system with respect to the environment. As the object to be detected is preferably temporally constant with respect to its orientation, a change in the orientation of the locating system with respect to the environment is typically equivalent to a change in a relative orientation with respect to the object to be located. Preferably, at least at a moment in time, an orientation of the locating system with respect to the environment is known to enable calibration of the second signal. However, such calibration with respect to the environment is not mandatory because the relative position information does not have to make reference to the environment, since it may only refer to relations between the locating system and the object. It is also contemplated, in particular, that the locating system at a point in time, for example, when placed on the examination surface determines one or more reference values for an orientation and/or a position of the locating system, for example, as a reference angle for the orientation, an angle value determined at the time of placing and/or as a reference point for the position, a point of the examination surface, wherein the reference value(s) can be used by the locating system at later times to compare with the current orientation and/or current position.

For example, the orientation sensor may be a path sensor configured to determine a path traveled by the locating system and/or a direction of movement sensor configured to determine a direction of movement of the locating system relative to an environment of the locating system and/or a path sensor and/or a direction of movement sensor. In this case, a movement direction sensor may be configured as an orientation sensor or as part of the orientation sensor purely for measuring a direction of movement of the locating system. For example, an orientation sensor may be configured as an optical and/or mechanical path sensor that captures movement and/or rotation in an operating state with a change in an orientation of the locating system relative to an environment of the locating system. Preferably, the locating system is configured such that the orientation sensor comprises a path sensor and/or a motion direction sensor, in particular an IMU (Inertial Measurement Unit).

The orientation sensor may in particular also be, or comprise, a position sensor for capturing position data of the locating system relative to the examination surface. A change in the direction of movement of the locating system results in a corresponding change in a position of the locating system that shows the change in the direction of movement. Thus, the direction of movement can be inferred from the signal of a position sensor changing with the direction of movement. A position sensor may in particular be a sensor provided to convert a field change, a runtime change, and/or a phase shift into an electrical signal to determine a current position of the locating system on the examination surface based thereon. The current position may be captured relative to a previous position, or absolutely, in particular with respect to at least one fixed reference point of the examination surface, and outputted or transmitted as position data. Preferably, the position sensor may also determine an orientation of the position sensor and thus the locating system. The position data relates to at least coordinates in two directions that determine the position of the position sensor on the examination surface. Further, position data may also determine an orientation of the position sensor relative to the examination surface.

The evaluation device is configured to determine the relative position information with respect to the relative position of the locating system relative to the object, taking into account the first signal and the second signal, for example by calculating the two signals, wherein the signals are typically transmitted wired from the locating sensor and the orientation sensor to the evaluation device. In this case, a determination of the relative position information taking into account the first signal and the second signal should be understood to mean further processing of the signals, such that information obtained from both signals is used to generate the relative position information, wherein a pure assignment of the signals or information obtained from it does not represent a determination to one another. In the case of multiple locating sensors, each of the plurality of locating sensors may provide its own first signal that is transmitted to the evaluation device and considered by it when determining the relative position information. It is also contemplated that the evaluation device is configured to determine relative position information regarding the relative position of the locating system relative to a plurality of objects, taking into account the first signal and the second signal. Thus, the locating system may be used to locate a plurality of objects located below the examination surface and determine their relative position information. The presence of at least two locating objects can be concluded by the evaluation device, for example, if the amplitude of the first signal first decreases and then increases again in a straight-line movement of the locating system.

In contrast to the prior art, complex sensors are not required for the position determination. For example, the relative position information can be determined using a path sensor with greatly reduced requirements compared to the sensors used in the state of the art, i.e. in particular larger measurement errors, or using a direction of movement sensor for the sole measurement of a direction of movement. For example, an orientation sensor may be implemented by wheels or a ball in combination with a device for determining its movements, by strain gauges for measuring a deformation, for example by flexibly mounted sliders, by a device for correlating images of the subsurface (optical tracking) and/or by a device for measuring speed, for example, by way of Doppler radar or laser interferometry. Furthermore, it is also contemplated that an orientation sensor is or comprises a device for performing SLAM (Simultaneous Locating and Mapping) and/or an IMU (Inertial Measurement Unit).

It is particularly advantageous if the evaluation device is configured to determine a change of the first signal, preferably a change of an amplitude of the first signal. In such a case, the evaluation device does not rely on absolute values of the first signal to determine the relative position information. The change can in particular be a time change. The change can thus be in the form of a gradient and/or a slope, for example in relation to time, if the first signal is considered as a function of time. By observing the time change of the first signal when the locating system moves, it is possible to determine whether the locating system is approaching the object or moving away from it, wherein the direction of movement of the locating system is typically not apparent from the first signal alone. However, in combination with the second signal from which at least estimates regarding the direction of movement of the locating system can be determined, at least one estimate can then be determined as to the direction in which the object is in relation to the locating system, i.e. in the case of which direction of movement the object is approached or removed. In an embodiment of the disclosure that is particularly easy to implement, when the object is detected to be approaching, the evaluation device concludes in a simplified manner that the object is located in the direction of the currently estimated direction of movement on the basis of the second signal. Conversely, if a distance from the object is detected, the simplified conclusion is that the object is in the opposite direction to the estimated direction of movement. Such a binary position indication (object is in/opposite the direction of movement) is relative position information.

Preferably, the evaluation device can be configured to determine time changes of the second signal, preferably a time change of an amplitude of the second signal. The evaluation device can in particular be configured so that the relative position information with respect to the relative position of the locating system relative to the object is determined, taking into account the first signal and the second signal, by the evaluation device determining time changes in both the first signal and the second signal and offsetting them against each other. This is particularly advantageous because a user of a locating system according to the disclosure, in particular in the case of a handheld locating device, does not typically guide it perfectly along a horizontal path on the examination surface, but unintentionally, for example, in curved and/or undulating paths. These path changes lead to constant changes in the direction of movement and thus also the orientation of the locating system in relation to the environment, which typically results in a change in both the first signal and the second signal. The changes in both signals can then be used by the evaluation device to determine the approximate direction in which the object is located in relation to the locating system at a particular time. Such consideration and calculation of the time changes of both signals allows a more precise determination of the relative position of the object than when using a current absolute value for the direction of movement of the locating system, as by considering the time changes of the second signal (caused by undesired deviations from a linear movement by the user), it may be differentiated between cases in which the object is located exactly in or laterally to the current direction of movement.

Advantageously, the locating system comprises an output unit configured to transmit the determined relative position information to the object, preferably optically, to a user of the locating system, i.e. to indicate, for example, in which direction the object, in particular the object center, is located. The relative position information is advantageous for the user to quickly find the object center. Elements of the output unit that directly serve to transmit relative position information to the user of the locating system, for example, illuminants of the output unit, are referred to as display elements in the context of the present disclosure.

A transmission of the relative position information to the user can be done optically, for example, using illuminants such as LEDs (light diodes), light arrows (i.e., light indicators in arrow form or similar form) and/or a display screen. For example, an approximate direction in which the object is estimated may be displayed with two LEDs and/or light arrows corresponding to the left and right options, for example. Four LEDs and/or light arrows can additionally be used to indicate a further directional option (e.g., at the top and bottom). With further LEDs and/or light arrows and/or simultaneous activation of several LEDs and/or light arrows, the indicated direction can be further specified. Light arrows may be realized in a variety of ways, for example, with LEDs and/or with light guides and/or shown on a display screen. Further, not only directional information but also distance information may be visually made available to a user. This may be done, for example, in that the intensity of the light arrows is dependent upon the distance of the locating system to the object and/or that additional LEDs are activated upon approaching the object. In the case of light arrows, it is also contemplated that several or all of the light arrows will be illuminated as soon as the locating system distance to the object drops below a certain value at least with respect to an axis (i.e. left-right, top-bottom). A particularly simple variant of the optical transmission of relative position information to the user can be accomplished by having an approximate position of the object to be detected relative to the position of the locating system carried out using three illuminants, for example LEDs: The first illuminant is then activated when the object is below or in a particular radius of the locating system. The second illuminant is then activated when the object is to the left of the locating system. In the event that the object is to the right of the locating system, finally the third illuminant is activated. With further illuminants, precise position information and/or the indication of further directions are possible.

In general, the display of relative position information by the output unit may also be made dependent on conditions, such as values of the sensors and/or the presence of display elements of the output unit. Thus, it is contemplated that a display element for indicating the direction in which the object is located will only be activated if an object has ever been detected. All display elements could also be disabled if they only correspond to the reflection of a position to the left or right of the locating system, if the object is located substantially above or below the locating system and therefore the use of the display elements for left/right could be misleading for a user of the locating system.

Alternatively or additionally, acoustic signals such as signal sounds and/or haptic signals such as vibrations are also conceivable. Accordingly, the output unit may in particular comprise an LED, a display screen, a speaker and/or a vibration generator. In particular, the output unit may inform the user when the locating system is moved by the user as to whether the user is moving the locating system in the direction of the object. Also, the locating system may directly prompt the user to move the locating system towards the object, onto the object, and/or over the object. This typically allows the locating system to capture the object even more accurately.

According to a second aspect of the disclosure, a method for determining relative position information by way of a locating system, preferably as described herein, is proposed with respect to a relative position of the locating system relative to an object to be located below an examination surface. This method includes providing a first signal by a locating sensor of the locating system, wherein the first signal changes with a change in a distance between the locating system and the object, providing a second signal by an orientation sensor of the locating system, wherein the second signal changes with a change in a direction of movement of the locating system relative to an environment of the locating system, and determining the relative position information taking into account the first signal and the second signal by an evaluation device of the locating system. In this case, the determination may be or comprise offsetting the signals with a previous signal processing and/or signal processing of one or both of the two signals.

Preferably, at least a portion of the locating system comprising the locating sensor and the orientation sensor (i.e., the locating device) or the entire locating system is automated or moved by a user via the examination interface to determine the relative position information by way of the locating system, thereby changing the first and second signals. Preferably, the method further comprises transmitting the determined relative position information to a user of the locating system by an output unit of the locating system, preferably wherein the transmitting is performed optically, for example by way of illuminants such as LEDs, light arrows and/or a display screen. It is thus contemplated, for example, that the user may move the locating system or its locating device over a wall surface as the examination surface to detect a hidden object such as an electrical line or pipe. Based on the first signal and the second signal, the evaluation device determines an estimate for the direction of the object and indicates this to the user, for example, by way of a light arrow. This direction corresponds to a direction in which the amplitude of the first signal increases. However, the evaluation device can also be configured such that distance and direction of the object are determined from the two signals and displayed to the user on a screen of the locating system.

Further, the method may comprise determining one or more offset values for the first signal and/or the second signal, and determining the relative position information comprises removing an offset for the first and/or the second signal, taking into account the one or more determined offset values. Such determination of offset values is advantageous, for example, in the event that the orientation sensor is or comprises an IMU: By using corresponding software (a Sensor Fusion Library), it is possible to estimate an orientation of the IMU, but values for a position of the IMU are subjected to a large drift. This is because an IMU typically uses acceleration values in all three spatial directions in order to determine values for a position from these, which consequently requires integrating twice. If offset errors, i.e. undesired offset values, are present in the acceleration values, they lead to highly distorted position values. Offset errors are also problematic for determining a direction of motion that is typically accomplished via a single integration of the acceleration values. Therefore, determining and removing offset values is particularly important for small accelerations and speeds.

Advantageously, the second signal includes acceleration values for the locating system and the one or more offset values are determined for the second signal during a motion stop of the locating system. Such a stop has proven to be the most suitable phase of operation for this purpose. In the case of an IMU, such a stop may be determined using acceleration values and/or rotational rates captured by the IMU. In particular, a determined rotational rate of the plane that is perpendicular to the examination surface on which the locating system will move is particularly meaningful in determining whether the locating system is resting or in motion.

Furthermore, determining the relative position information may comprise taking into account the change in the first signal and/or the second signal, preferably wherein the change in the first signal and/or the second signal comprises or is a change in an amplitude of the first signal and/or the second signal.

The disclosure describes an approach for a locating system, in particular a handheld locating device, for locating an object to be located under an examination surface, such as a wall surface, in which corresponding relative position information is determined by an evaluation device taking into account the electrical signals of a locating sensor and an orientation sensor. The basic idea is to use the information obtained by the two sensors to improve the locating result for a user, and relative position information such as a distance of the locating system to the object to be located and/or a relative orientation of the locating system in relation to the object to be located and/or a direction of the object to be located in relation to the locating system can be displayed. Any shortcomings of one or both of the sensors may thereby be at least partially compensated for.

This approach thus enables an advantageous procedure for locating objects located under an examination surface, since only reduced requirements have to be placed on the sensors used, in particular on the orientation sensor used. In order to implement the disclosure, the orientation sensor is only required for a rough determination of the direction of movement of the locating system; exact position determination and the associated complex sensor technology are not required.

The locating system may provide a user of a locating system according to the present disclosure with an approximate estimate of the distance and/or direction of the object to be located by the locating system, for example, using illuminants such as LEDs and/or light arrows, in which direction a hidden object is located. This is often sufficient for the user to quickly locate the center of the object.

### BRIEF DESCRIPTION OF THE DRAWINGS

Embodiments of the disclosure are described in greater detail hereinafter with reference to the drawings and the subsequent description.

The figures show:

FIG. 1 a schematic view of an exemplary locating system according to the present disclosure;

FIG. 2 is a schematic flow chart illustrating an exemplary method for determining relative position information according to the present disclosure; and

FIGS. 3A, 3B schematic representations for illustrating the operation of an exemplary locating system according to the disclosure and an exemplary method according to the disclosure.

### DETAILED DESCRIPTION

In the following description of the embodiments of the disclosure, identical or similar elements are denoted by identical reference signs, whereby a repeated description of these elements is omitted in individual cases. The drawings show the subject matter of the disclosure only schematically.

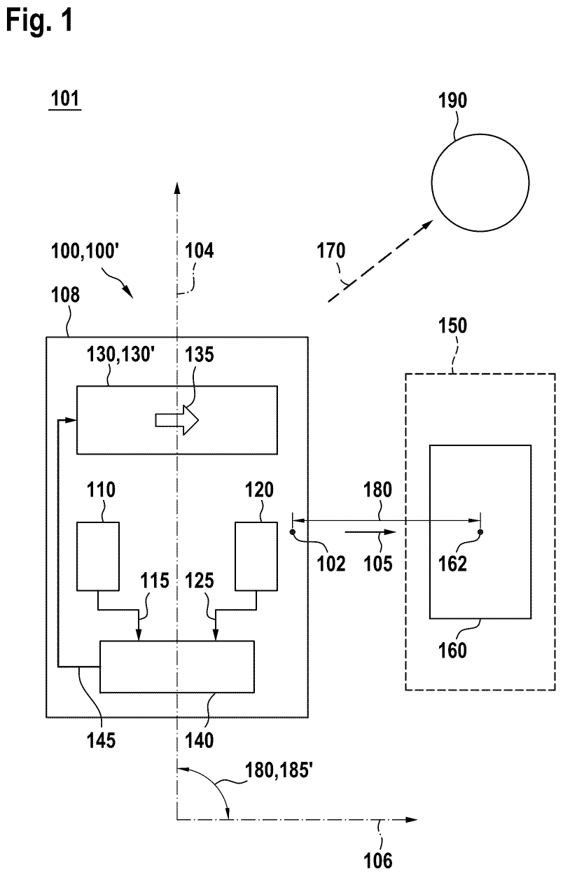

FIG. 1 shows a schematic view of an exemplary locating system 100 according to the present disclosure. This is a handheld locating device 100′ having a display screen 130′ as part of an output unit 130, wherein the locating system 100 is located in an environment 101. Further, the locating system 100 includes a locating sensor 110, an orientation sensor 120, and an evaluation device 140, wherein the sensors 110, 120 are connected to the evaluation device 140 by way of cables 115, 125 for electrical signal transmission. The evaluation device 140 in turn is connected to the output unit 130 by way of a cable 145 for electrical signal transmission. The locating system 100 includes a housing 108 that at least partially encloses these components 110, 115, 120, 125, 130, 140, 145 and into which the display screen 130′ is embedded.

The locating system 100 is guided to locate an object 160 to be located under an examination surface 150 by a human user 190 via the examination surface 150. The locating system 100 can determine relative position information regarding a relative position of the locating system 100 relative to the object 160 to be located. The locating sensor 110 and the orientation sensor 120 are used for this purpose in combination with the locating device 140, wherein the locating sensor 110 provides a first signal that changes with a change in a distance 180 between the locating system 100 and the object 160. Here, the distance 180 refers to the distance between a reference point 102 of the locating system 100 and the object center 162. The orientation sensor 120 is configured to provide a second signal that changes with a change in a direction of movement 105 of the locating system 100 relative to the environment 101 of the locating system 100. It is contemplated, for example, that the orientation sensor 120 captures an orientation 185, for example, via a determination of an approximate value for an angle 185′ between a reference axis 104 of locating system 100 and a temporally constant axis 106 relative to the environment 101. The angle 185′ is thus independent of the location of the object 160.

The angle 185′ allows a statement to be made about the direction of movement 105 of the locating system 100 when the locating system 100 is moved over the examination surface 150, provided that the locating system 100 is moved such that there is a substantially constant orientation of the locating system 100 with respect to its direction of movement 105. Together with the change in the distance 180, the angle 185′ allows a statement to be made as to whether, when moving in the direction of movement 105, the object 160 is approached or whether this results in moving away from the object 160, i.e. in which direction the object 160 is at least roughly located. The information obtained during the movement of the locating system 100, i.e., the location of the object 160 roughly in the direction of movement 105 or opposite the direction of movement 105, represents relative position information determined by the evaluation mechanism 140 using the first signal and the second signal. However, it is also conceivable, for example, that the orientation sensor 120 is implemented as a path sensor, the signal of which allows at least approximate information regarding a traveled path on the examination interface 150 so that changes in the orientation 185 of the locating system 100 and the direction of movement 105 can be concluded from this information. Equivalent to the case described above, it can then also be determined here whether the object 160 is roughly in the direction of movement 105 or opposite to the direction of movement 105.

The relative position information thus obtained may now be displayed, for example, by way of the display screen 130′ of the output unit 130, for example in the form of light arrows 135, which point to the left or right relative to the locating system 100, and thus transmitted optically to the user 190 of the locating system 100 (schematically represented by an arrow 170).

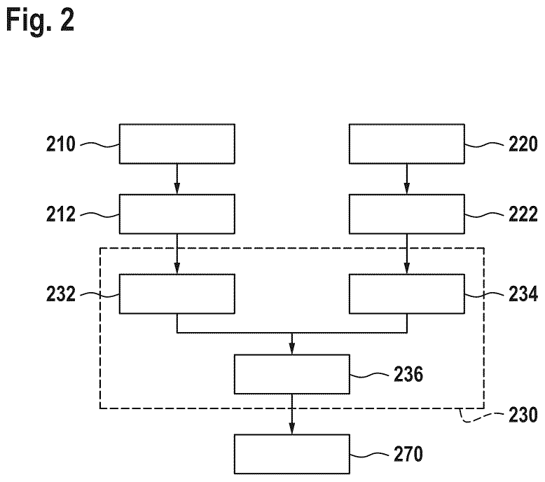

FIG. 2 shows a schematic flow diagram explaining an exemplary method according to the disclosure for determining relative position information by way of a locating system 100, for example as shown in FIG. 1, with respect to a relative position of the locating system 100 relative to an object 160 to be located under an examination surface 150. This method includes providing 210 a first signal by a locating sensor 110 of the locating system 100, wherein the first signal changes with a change in a distance 180 between the locating sensor 110 and the object 160, providing 220 a second signal by an orientation sensor 120 of the locating system 100, wherein the second signal changes with a change in a direction of movement 105 of the locating system 100 relative to an environment 101 of the locating system 100. Optionally, a determination 212, 222 of one or more offset values for the first signal and/or for the second signal is still performed to avoid errors in signal processing. Determination of the offset values may advantageously occur during a motion stop of the locating system 100.

After determining 212, 222 the offset values, determining 230 the relative position information may be performed while continuously capturing the first and second signals. This includes removing 232, 234 an offset for the first and/or the second signal, taking into account the one or more determined offset values. The actual determination of the relative position information is then carried out taking into account the first signal and the second signal. This can be done, for example, by offsetting 236 the two signals, and in particular by the evaluation device 140 determining time changes in both the first signal and the second signal and offsetting them against each other to obtain the relative position information. Preferably, a time change of an amplitude of the first signal and/or a time change of an amplitude of the second signal is considered.

Finally, the determined relative position information is transmitted to a user 190 of the locating system 100 by an output unit 130 of the locating system 100 in step 270, wherein this transmission 270 id preferably optical, for example by way of light arrows 135 and/or a display screen 130′.

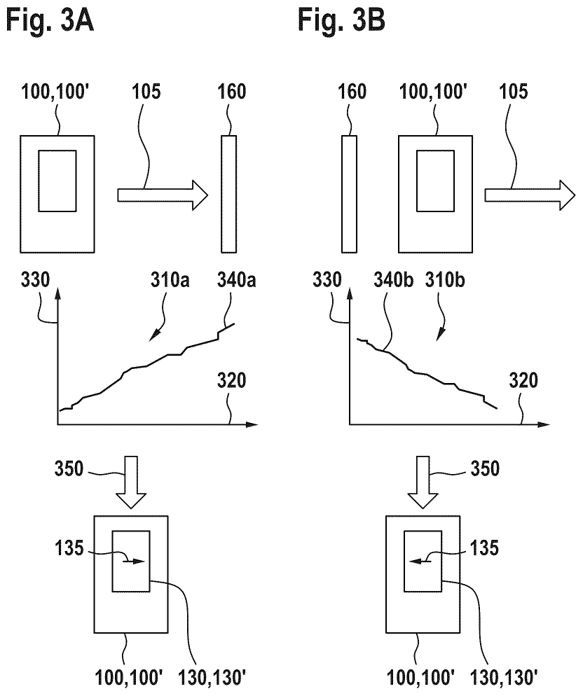

Finally, FIGS. 3A and 3B show diagrams for further illustrating the operation of the exemplary locating system 100 according to the disclosure of FIG. 1 and an exemplary method according to the disclosure.

The upper third of FIG. 3A shows a situation in as already shown in FIG. 1. The locating system 100, a handheld locating device 100′, is moved toward the object 160 to be located under an examination surface 150. Here, in FIG. 3A, the direction of movement 105 is illustrated by an arrow.

Below this representation, a graph 310a is shown in FIG. 3A that shows the amplitude of the first signal of the locating sensor 110 (y-axis 330) plotted against time (x-axis 320). As can be seen, the curve 340a resulting therefrom is increasing, i.e. the amplitude of the first signal becomes greater with time. Determining an at least rough statement about the direction of movement 105 may be performed using the second signal of orientation sensor 120.

Based on this information, i.e. taking into account the first signal and the second signal of both sensors 110 and 120, illustrated by arrow 350, relative position information regarding the relative position of the locating system 100 relative to the object 160 may consequently be determined by the evaluation device 140: It can be concluded from the increasing curve 340a that the object 160 is approached in the direction of movement 105. By knowing the approximate direction of movement 105 based on the signal from the orientation sensor 120, namely that this is from left to right in relation to the illustration of FIG. 3A, it can be further concluded that the object 160 must also be on the right side of the handheld locating device 100′. For example, the output unit 130 of the handheld locating device 100′ may now display a light arrow 135, for example via a display screen 130′ of the output unit 130 pointing in the approximate assumed direction of the object 160, and thereby transmit the relative position information determined by the evaluation device 140 to a user 190 of the handheld locating device 100′.

Conversely, FIG. 3B shows the situation for a decreasing temporal course of the amplitude of the signal of the locating sensor 110. The corresponding curve 340b is shown in graph 310b. The determination 230 of the relative position information taking into account the first signal and the second signal is done analogously to the case of FIG. 3A: From the drop in the amplitude of the first signal, the evaluation device 140 can conclude that in this case the handheld locating device 100′ is moving away from the object 160 when moving in the direction of movement 105. Based on knowledge of the direction of movement 105, it can further be concluded that the object 160 is located on the left-side of the handheld locating device 100′ relative to the illustration of FIG. 3B. Again, this relative position information may be communicated to a user 190 by way of the output unit 130 by way of a light arrow 135, which in this case points in the opposite direction to the direction of the illuminated arrow 135 of FIG. 3A.

The disclosure is not limited to the exemplary embodiments described herein and the aspects highlighted thereby. Rather, within the range specified by the claims, a plurality of modifications is possible, which lie within the abilities of a person skilled in the art.

What is claimed is:

1. A locating system for determining relative position information with respect to a relative position of the locating system relative to an object to be located below an examination surface, comprising:
a locating sensor configured to provide a first signal that changes with a change of a distance between the locating system and the object;
an orientation sensor configured to provide a second signal that changes with a change of a direction of movement of the locating system relative to an environment of the locating system; and
an evaluation device configured to determine the relative position information with respect to the relative position of the locating system relative to the object taking into account the first signal and the second signal.

2. The locating system of claim 1, wherein the evaluation mechanism is further configured to determine a change of the first signal and/or the second signal.

3. The locating system of claim 1, wherein the orientation sensor comprises a path sensor and/or a motion direction sensor.

4. The locating system of claim 1, further comprising an output unit configured to optically transmit the determined relative position information relative to the object to a user of the locating system.

5. The locating system of claim 4, wherein the output unit comprises an LED, a display screen, a speaker, and/or a vibration generator.

6. A method for determining relative position information by way of the locating system according to claim 1, with respect to a relative position of the locating system relative to an object to be located below an examination surface, comprising:
a) providing a first signal by a locating sensor of the locating system, wherein the first signal changes with a change in a distance between the locating sensor and the object;
b) providing a second signal by an orientation sensor of the locating system, wherein the second signal changes with a change in a direction of movement of the locating system relative to an environment of the locating system; and
c) determining the relative position information taking into account the first signal and the second signal by an evaluation device of the locating system.

7. The method of claim 6, further comprising transmitting the determined relative position information to a user of the locating system by an output unit of the locating system.

8. The method of claim 6, further comprising determining one or more offset values for the first signal and/or for the second signal, wherein:
determining the relative position information comprises removing an offset for the first and/or the second signal, taking into account the one or more determined offset values.

9. The method of claim 8, wherein:
the second signal includes acceleration values for the locating system, and
determining the one or more offset values for the second signal is performed during a motion stop of the locating system.

10. The method of claim 6, wherein determining the relative position information comprises taking into account the change in the first signal and/or the second signal.

11. The locating system of claim 1, wherein the locating system is a handheld locating device.

12. The locating system of claim 1, wherein the evaluation mechanism is further configured to determine a change in an amplitude of the first signal and/or the second signal.

13. The locating system of claim 3, wherein the motion direction sensor is an IMU.

14. The method of claim 7, wherein the transmission is optical.

15. The method of claim 10, wherein the change in the first signal and/or the second signal comprises or is a change in an amplitude of the first signal and/or the second signal.
